(19) United States
(12) Patent Application Publication
(10) Pub. No.: US 2017/0268527 A1
(43) Pub. Date: Sep. 21, 2017

(54) IMPELLER FOR SUPERCHARGER

(71) Applicant: KAWASAKI JUKOGYO KABUSHIKI KAISHA, Kobe-shi (JP)

(72) Inventors: Shohei Naruoka, Kakogawa-shi (JP); Hiroyuki Watanabe, Akashi-shi (JP)

(21) Appl. No.: 15/611,654

(22) Filed: Jun. 1, 2017

Related U.S. Application Data
(63) Continuation of application No. PCT/JP2015/083285, filed on Nov. 26, 2015.

(30) Foreign Application Priority Data
Dec. 11, 2014 (JP) 2014-250758
Dec. 11, 2014 (JP) 2014-250759

(51) Int. Cl. F04D 29/28; F02B 33/40; F04D 25/02; F04D 25/08; F02B 39/04; F04D 17/10; F02B 61/02

(52) U.S. Cl. CPC F04D 29/284; F04D 17/10; F02B 33/40; F02B 61/02; F04D 25/08; F02B 39/04; F04D 25/028

(57) ABSTRACT

An impeller (60) for use in a supercharger (42), which is cable of increasing the efficiency while suppressing the increase in size of the impeller (60), is driven in driving connection with a crankshaft (26) of a combustion engine (E) mounted on a motorcycle to supply an intake air (I) towards the combustion engine (E). When the supercharger (42) is driven at a maximum permissible engine speed of an inlet diameter (Ii), the impeller (60) is so set that the peripheral velocity at an inlet side tip end portion (112) of the impeller (60) may exceed the sonic velocity, and may be smaller than 1.3 times the sonic velocity.

### CROSS REFERENCE TO THE RELATED APPLICATION

This application is a continuation application, under 35 U.S.C. §111(a) of international patent application No. PCT/JP2015/083285, filed Nov. 26, 2015, which claims priority to Japanese patent applications No. 2014-250758 and No. 2014-250759, both filed Dec. 11, 1014, the entire disclosures of which are herein incorporated by reference as a part of this application.

### BACKGROUND OF THE INVENTION

Field of the Invention

The present invention relates to a centrifugal impeller for a supercharger drivingly connected with a crankshaft of a combustion engine, mounted on a motorcycle, for supplying an intake air to the combustion engine.

Description of Related Art

In a combustion engine employed in a motorcycle, the use of a supercharger including a centrifugal impeller drivingly connected with a crankshaft of the combustion engine is known for supplying an intake air towards the combustion engine. In this connection, see, for example, the patent document 1 listed below.

### PRIOR ART LITERATURE

Patent Document 1: JP Laid-open Patent Publication No. 2013-224614

Since in the motorcycle, the space available for installation of instruments and equipment is limited, desires have arisen to reduce the supercharger as much as possible. However, downsizing the supercharger may lead to reduction in efficiency to such an extent as to result in incapability of acquiring a desired amount of intake air.

### SUMMARY OF THE INVENTION

In view of the above, the present invention has an object to provide an impeller for the supercharger which can have an improved efficiency while avoiding an increase of the size of the impeller.

In order to accomplish the foregoing object, a centrifugal impeller in accordance with one aspect of the present invention is of a type drivingly connected with a crankshaft of a motorcycle combustion engine, mounted on the motorcycle, which impeller supplies an intake air towards the combustion engine, in which as the supercharger is driven at a maximum permissible engine speed, an inlet diameter of the impeller is chosen to be a value that allows a peripheral velocity of an inlet side tip end portion (tip end portion) of the impeller to exceed the sonic velocity. It is to be noted that the term “maximum permissible engine speed” referred to above and hereinafter is to be understood as meaning the maximum design engine speed except for that occurring under the overrun condition of the engine which would be brought about by an abnormal reduction of the load.

According to the present invention, the inlet diameter of the impeller is so set that at the maximum permissible engine speed the peripheral velocity of the tip end portion may exceed the acoustic speed. Therefore, the peripheral velocity, in a normal operating region not higher than the maximum permissible engine speed, can be brought close to the acoustic speed. As a result, the efficiency under the normal operating region is increased accompanied by increase of the engine output.

In one embodiment of the present invention, the inlet diameter may be so set that the peripheral velocity of the inlet side tip end portion of the impeller at the maximum permissible engine speed is equal to or lower than 1.3 times the sonic velocity. According to this feature, even at the maximum permissible engine speed, the amount of reduction of the engine output is small and the maximum output can be improved easily.

In another embodiment of the present invention, a trim value may be equal to or higher than 50%. According to this feature, setting the trim value at a value higher than 50% makes it possible to relatively reduce the outlet diameter and, therefore, even in the motorcycle in which the space available is limited, the supercharger can be easily mounted.

In a further embodiment of the present invention, the backward angle of the blade may be set to a positive value. The blade length is reduced if the impeller to be mounted on the motorcycle is reduced in size. According to this further embodiment, the backward angle is set to the positive value, and therefore, the blade length ca be increased while the impeller is downsized and reduction in efficiency of the supercharger can be suppressed.

Where the backward angle is set to the positive value, rotation of the crankshaft is transmitted to a supercharger rotary shaft, on which the impeller is fixed, through the planetary gear device, and the planetary gear device may transmit the rotation of the crankshaft to the supercharger after the speed of such rotation has been increased. The impeller may be fixed on one end portion of the supercharger rotary shaft and the planetary gear device may be connected with the other end portion of the supercharger rotary shaft. In such case, an outlet diameter of the impeller may be set to a value smaller than the outer diameter of the planetary gear device. According to this feature, even when the output diameter of the impeller is limited, setting of the backward angle to the positive value makes it possible to suppress the reduction in efficiency of the supercharger while the impeller is downsized.

In a still further embodiment of the present invention, the impeller may include: a plurality of main blades disposed spaced a distance from each other in a peripheral direction; and a plurality of splitter blades each disposed between the neighboring main blades, in which case each of the main blades has a maximum thickness portion defined at an intermediate portion with respect to a direction of flow, the maximum thickness portion having a maximum thickness, and each of the splitter blades has a front edge, portions of which the front edge and the maximum thickness portion of the corresponding main blade are displaced in the direction of flow of intake air. According to this feature, since abrupt narrowing of the flow path in the presence of the splitter blades is avoided, the efficiency can be improved.

In a yet further embodiment of the present invention, the impeller may include a blade, a surface of which may be formed along a direction of flow of the intake air by means of a cutting process. According to this feature, the intake air flows along grooves formed by the cutting process, and therefore, flow loss is reduced, thereby to increase the efficiency of the supercharger.

In a further embodiment of the present invention, the impeller may be fixed, with the use of a fixture member, on a supercharger rotary shaft the that is inserted through a throughhole defined in the impeller, and may include: an impeller main body formed with blades; a front end portion protruding towards one axial side from the impeller main body and held in contact with the fixture member; and a rear end portion protruding towards the other axial side from the impeller main body and held in contact with a flanged portion of the supercharger rotary shaft, in which case an outer diameter of an end face of the rear end portion is so set as to be larger than an outer diameter of an end face of the front end portion.

According to the above discussed feature, since the outer diameter of the end face of the rear end portion is set to a value larger than the outer diameter of the end face of the front end portion, the strength against the tensile force acting to pull the rear end portion in the radial outward side improves. Accordingly, in the event that the supercharger rotary shaft is driven at a high speed, even when the high tensile force acting in the radially outer side as a result of the centrifugal force acts on an outer peripheral portion on the rear end side of the impeller main body, at which outer diameter is largest, the possibility that the rear end side of the impeller main body is affected by such tensile force can be suppressed. Accordingly, the impeller can be driven at a high speed.

Where the outer diameter of the end face of the rear end portion is set to a value larger than the outer diameter of the end face of the front end portion, the outer diameter of the end face of the rear end portion may be smaller than the outer diameter of the front end portion of the impeller main body. According to this feature, the increase of the centrifugal force is suppressed while the increase of the size of the rear end portion is avoided, and also, reduction of the weight of the impeller can be achieved.

Where the outer diameter of the end face of the rear end portion is set to a value larger than the outer diameter of the end face of the front end portion, an outer diametric dimension of the rear end portion may gradually increase from the end face thereof towards the impeller main body, in which case an outer diametric dimension of a boundary portion between the rear end portion and the impeller main body is larger than half an outer diametric dimension of a base end of the impeller main body, and smaller than an outer diametric dimension of a tip end of the impeller main body. According to this feature, the stress concentration at the boundary portion is suppressed, while the rigidity of the rear end portion is increased. Further, the increase of the outer peripheral edge portion on the rear end side of the impeller is suppressed, thereby to reduce the centrifugal force.

Where the outer diameter of the end face of the rear end portion is set to a value larger than the outer diameter of the end face of the front end portion, a dimension of projection of the rear end portion from the impeller main body may be set to be larger than a difference between a radius of the throughhole and a radius of the end face of the front end portion. According to this feature, the amount of projection of the rear end portion becomes large, and therefore, the reduction of the rigidity of the rear end side of the impeller main body can be suppressed.

Where the outer diameter of the end face of the rear end portion is set to a value larger than the outer diameter of the end face of the front end portion, the rear end portion may be opposed axially to a sealing member disposed on a radially outward side of the flanged portion. According to this feature, the axial gap between the sealing member and the impeller is rendered to be so small, and therefore, any possible leakage of the lubricant fluid can be avoided.

A centrifugal impeller in a supercharger in accordance with another aspect of the present invention may be fixed, with the use of a fixture member, on a supercharger rotary shaft the that is inserted through a throughhole defined in the impeller, and may include: an impeller main body formed with blades; a front end portion protruding towards one axial side from the impeller main body and held in contact with the fixture member; and a rear end portion protruding towards the other axial side from the impeller main body and held in contact with a flanged portion of the supercharger rotary shaft, in which case an outer diameter of an end face of the rear end portion is so set as to be larger than an outer diameter of an end face of the front end portion.

In the supercharger disclosed in the patent document 1 referred to above, the outer diameter is largest at the rear end side of the impeller main body. In the supercharger of this kind, if the supercharger rotary shaft is driven at a high speed in order to improve the engine output, the outer peripheral portion at the rear end side of the impeller main body, at which the outer diameter is largest, is affected by the high tensile force acting radially outwardly as brought about by the centrifugal force. Since there is the possibility that such tensile force remains in the form of the residue stress, the speed-up of the rotation is limited in the case of particularly the small sized impeller.

According to the impeller employed in the supercharger in accordance with another aspect of the present invention, the outer diameter of the end face of the rear end portion is set to a value larger than the outer diameter of the end face of the front end portion. As a result, the strength against the tensile force acting to pull the rear end portion in the radial outward side improves. Accordingly, in the event that the supercharger rotary shaft is driven at a high speed, even when the high tensile force acting in the radially outer side as a result of the centrifugal force acts on an outer peripheral portion on the rear end side of the impeller main body, at which outer diameter is largest, the possibility that the rear end side of the impeller main body is affected by such tensile force can be suppressed. Therefore, the impeller can be driven at a high speed.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic side view showing a motorcycle employing a supercharger of a type provided with an impeller designed in accordance with a preferred embodiment of the present invention;

FIG. 2 is a horizontal sectional view showing the supercharger;

FIG. 3 is a schematic side view showing the impeller;

FIG. 4 is a schematic front elevational view showing the impeller as viewed in a direction facing towards a suction side;

FIG. 5 is a perspective view showing the impeller;

FIG. 6 is a schematic diagram showing the positional relationship between main blades and splitter blades both employed in the impeller; and

FIG. 7 is a front elevational view showing the cutting direction of one of the blades of the impeller.

### DESCRIPTION OF PREFERRED EMBODIMENTS

With reference to the accompanying drawings a preferred embodiment of the present invention will be hereinafter described. In describing the present invention, however, the terms “left” and “front”, or similar notations, that are hereinabove and hereinafter used are to be understood as meaning relative terms descriptive of positions and/or directions as viewed from a vehicle rider occupying the seat.

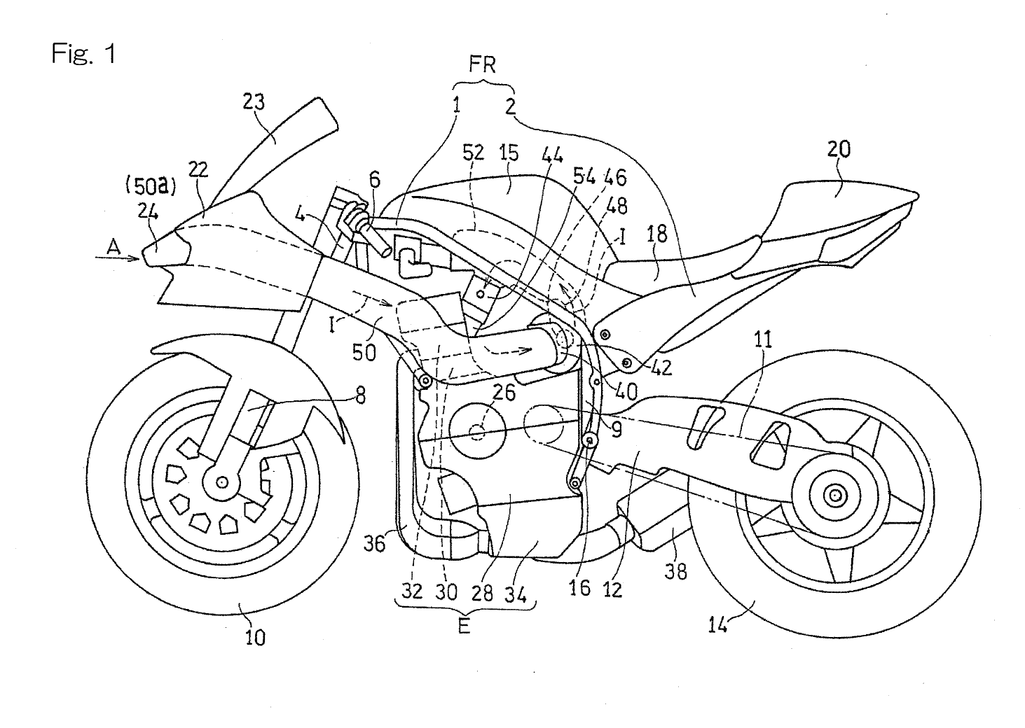

FIG. 1 is a schematic side view of a motorcycle employing an engine supercharger equipped with an impeller designed in accordance with the preferred embodiment of the present invention. The illustrated motorcycle includes a motorcycle frame structure FR made up of a main frame assembly 1, forming a front half portion of the motorcycle frame structure FR, and a rear frame assembly 2 forming a rear half portion of the same. The main frame assembly 1 has a head pipe 4 provided at a front end thereof, and a front fork 8 is rotatably supported by the head pipe 4 through a steering shaft (not shown). The front fork 8 has a lower end portion to which a front wheel 10 is fitted, and a motorcycle steering handlebar 6 is fixed to an upper end portion of the front fork 8.

A rear end portion of the main frame assembly 1, which is located at an intermediate lower portion of the motorcycle frame structure FR, is provided with a swingarm bracket 9. A swingarm 12 is supported for vertical movement about a pivot pin 16 fitted to the swingarm bracket 9. A rear wheel 14 is rotatably supported by a rear end portion of the swingarm 12. A motorcycle combustion engine E is fitted to an intermediate lower portion of the motorcycle frame structure FR and is positioned at a location forwardly of a front side of the swingarm bracket 9. This combustion engine E drives the rear wheel 14 through a drive transmitting member 11 such as, for example, an endless chain.

The combustion engine E includes a crankshaft 16 having a rotary axis that extends in a leftward and rightward direction (motorcycle widthwise direction), a crankcase 28 for supporting the crankshaft 26, a cylinder block 30 protruding upwardly from a front upper surface of the crankcase 28, a cylinder head 32 atop the cylinder block 30 and an oil pan 34 provided at a location below the crankcase 28. In the practice of the embodiment now under discussion, the crankcase 28 and the cylinder block 30 are formed integrally with each other by means of die forming and, hence, a rear portion of the crankcase 28 concurrently serves as a transmission casing. Although the combustion engine E in the present embodiment is employed in the form of a four cylinder four cycle combustion engine, the present invention is not necessarily limited thereto.

Four exhaust pipes 36 are fluid connected with a front surface of the cylinder head 32. Those four exhaust pipes 36 are merged together at a location beneath the combustion engine E and is in turn fluid connected with an exhaust muffler 38 that is disposed on a right side of the rear wheel 14.

A fuel tank 15 is disposed on an upper portion of the main frame assembly 1, and a driver's seat 18 and a fellow passenger's seat 20 are supported by the rear frame assembly 2. Also, a cowling or fairing 22 made of a synthetic resin is mounted on a motorcycle front portion while covering an area forwardly of the head pipe 4. This cowling 22 is forming with an air intake opening 24 defined at a front end of the cowling 22 for introducing an intake air from the outside towards the combustion engine E. A transparent windshield 23 is mounted on an upper portion of the cowling 22.

On a left side of the motorcycle frame structure FR, an air intake duct 50 is disposed. This air intake duct 50 has a front end opening 50a defined therein and is supported by the head pipe 4 with the front end opening 50a aligned with the air intake opening 24. Air introduced through the front end opening 50a of the air intake duct 50 is increased in pressure through the well-known ram effect. The air intake duct 50 extends rearwardly via a left lateral side of the cylinder block 30 and the cylinder head 32, to guide the incoming air A from an area forwardly of the combustion engine E into the combustion engine E as an intake air I.

An air cleaner 40 for substantially purifying the air and a supercharger 42 are positioned on an upper surface of the crankcase 28 and rearwardly of the cylinder block 30 in a fashion juxtaposed in the motorcycle widthwise direction relative to each other. The air intake duct 50 has a downstream end 50b fluid connected with a suction port 46 of the supercharger 42 through the air cleaner 40. This supercharger 42 is removably provided relative to the combustion engine E and is operable to pressurize the air purified by the air cleaner 40 before the air is supplied to the combustion engine E.

An intake air chamber 52 is intervened between a discharge port 48 of the supercharger 42 and an air intake port 54 in the combustion engine E, and the discharge port 48 of the supercharger 42 and the intake air chamber 52 are directly fluid connected with each other. The intake air chamber 52 serves to store the intake air I which has been supplied from the discharge port 48 of the supercharger 42. A throttle body 44 is disposed between the intake air chamber 52 and the air intake port 54. The intake air chamber 52 is positioned above the supercharger 42 and the throttle body 44. The fuel tank 15 referred to previously is positioned above the intake air chamber 52 and the throttle body 44.

The supercharger 42 is positioned upwardly of a rear portion of the crankcase 28 and is accommodated at a location intermediate of the crankcase 28 with respect to the motorcycle widthwise direction. In other words, the supercharger 42 is positioned rearwardly of the cylinder block 30 and the cylinder head 32 and above the rear portion of the crankcase 28. The supercharger 42 is disposed within a space which is defined below the intake air chamber 52 and inwardly of the span between opposite outer ends of the width of the crankcase 28 with respect to the motorcycle widthwise direction.

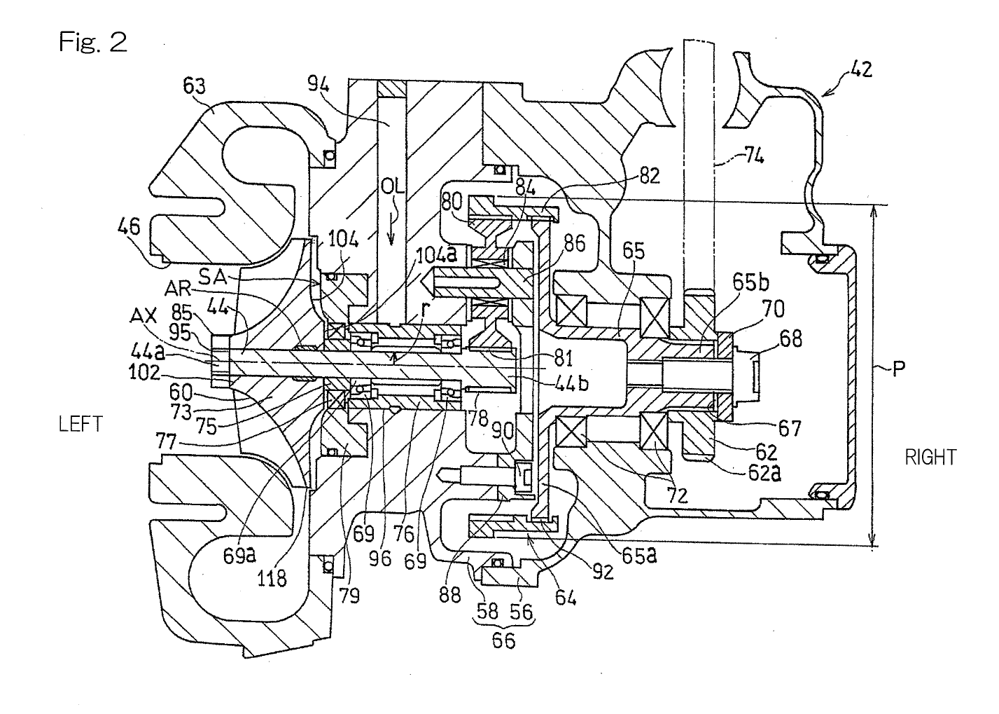

As shown in FIG. 2, the supercharger 42 employed in the practice of the embodiment now under discussion is of a centrifugal type and includes an impeller 60 fixed to one end portion (left side end portion) of a supercharger rotary shaft 44 that extends in the motorcycle widthwise direction (leftward and rightward direction), an impeller housing 63 enclosing the impeller 60, a supercharger casing 66 for rotatably supporting the supercharger rotary shaft 44, and a planetary gear device 64 for increasing the speed of rotation of the crankshaft 26 of the combustion engine E and then transmitting the rotation of the crankshaft 26 to the supercharger rotary shaft 44. In other words, the impeller 60 is fixed to one end portion 44a of the supercharger rotary shaft 44, and the other end portion 44b of the supercharger rotary shaft 44 is drivingly connected with the planetary gear device 64.

The maximum speed of the supercharger rotary shaft 44, which has been increased, attains a value equal to or higher than 100,000 per minute, particularly about 140,000 per minute in the practice of the embodiment now under discussion. Also, in the practice of the embodiment now under discussion, the intake air within the supercharger 42 is subjected to high temperature compression, and the temperature of the intake air so subjected to the high temperature compression attains about 100° C. as measured at the supercharger discharge port 48. Also, it is possible that the motorcycle may be abruptly accelerated and abruptly decelerated one at a time. Yet, with the combustion engine E under non-loaded condition, the maximum permissible speed may be attained in 0.5 second from the idling operation, and therefore, the centrifugal force imposed on the impeller 60 is considerably high. The details of the impeller 60 will be discussed later.

The supercharger 42 is powered by the combustion engine E. Specifically, a rotational force of the crankshaft 26 is transmitted to an input shaft 65 of the planetary gear device 64, which is drivingly connected with the supercharger rotary shaft 44, through a chain 74 which is a sort of drive transmitting member. More specifically, the input shaft 65 has a right side end portion provided with a sprocket 62 having sprocket gear tooth 62a, and the chain 74 is trained around those sprocket gear tooth 62a. In other words, the suction port 46 of the supercharger 42 is provided on one axial side (left side) of the supercharger rotary shaft 44, and the chain (drive transmitting mechanism) 74 is provided on the other axial side (right side) of the supercharger rotary shaft 44.

The supercharger casing 66 includes a right side input casing unit 56, in which the input shaft 65 and the sprocket 62 are accommodated, and a left side gear casing unit 58 accommodating therein the planetary gear device 64. The input casing unit 56 and the gear casing unit 58 are connected together by means of bolts (not shown). Also, the impeller housing 63 is connected with the gear casing unit 58 with the use of bolts (not shown).

The input shaft 65 is in the form of a hollow shaft and is rotatably supported in and by the input casing unit 56 through a pair of bearings 72. The input shaft 65 has a right side end portion 65b having an outer peripheral surface on which splined serrations 67 are formed. The sprocket 62 referred to previously is held in splined engagement with the splined serration 67 for rotation together with the input shaft 65. The input shaft 65 has a right side end portion 65b having an inner peripheral surface formed with a female threaded portion. By means of a head portion of a bolt 68 threaded to this female threaded portion, the sprocket 62 is fixed to the right side end portion 65b of the input shaft 65 through a washer 70.

A right side end portion 44b, which is a base end portion of the supercharger rotary shaft 44, is connected with a left side end portion 65a of the input shaft 65 through the planetary gear device 64. The left side end portion 65a of the input shaft 65 is constituted by a collar shaped flange portion 65a. The supercharger rotary shaft 44 is rotatably supported by the gear casing unit 58 through bearing 69. The bearing 69 is in practice employed two in number. Those two bearings 69 are juxtaposed in the axial direction and are accommodated within a bearing housing 76. The right side end portion 44b of the supercharger rotary shaft 44 is formed with external teeth 78.

The planetary gear device 64 is disposed between the input shaft 65 and the supercharger rotary shaft 44, and is supported in and by the casing unit 58. A plurality of circumferentially arranged planetary gears 80 are drivingly engaged with the external teeth 78 defined in the right side end portion 44b of the supercharger rotary shaft 44. In other words, the external teeth 78 of the supercharger rotary shaft 44 functions as a sun gear of the planetary gear device 64. The planetary gears 80 are formed with external teeth 81 engageable with the sun gear (external teeth) 78. The planetary gears 80 are spaced a distance from each other in the peripheral direction and, in the practice of the embodiment now under discussion, the number of those planetary gears 80 employed is three.

The planetary gears 80 are drivingly connected with an internally toothed wheel (ring gear) 82 of a large diameter positioned radially outwardly of such planetary gears 80. Each of the planetary gears 80 is rotatably supported by a corresponding carrier shaft 86 by means of a bearing 84 mounted in the gear casing unit 58. In other words, the carrier shaft 86 forms a support shaft for each planetary gear 80. In the practice of this embodiment now under discussion, a needle roller is employed for the bearing 84.

The carrier shaft 86 for each of the planetary gears 80 is fixed to a disc shaped fixing member 88, and this fixing member 88 is in turn fixed to the gear casing unit 58 by means of a bolt 90. In other words, the carrier shaft 86 is fixed and no planetary gear 80 can undergo revolution. The internally toothed wheel 82 is drivingly connected with an input gear 92 provided on the left side end portion of the input shaft 65. The input gear 92 is an externally toothed wheel made up of a disc having its outer periphery formed with external teeth.

As described above, the internally toothed wheel 82 is drivingly connected with the input shaft 65 so that the both can rotate integrally together in the same direction, and the planetary gears 80 rotate in the same direction as that of the internally toothed gear 82 while the carrier shaft 86 is fixed. The sun gear (external gear) 78 rotates in a direction counter to the direction of rotation of the planetary gears 80.

Within the interior of the supercharger casing 66, a supercharger lubricating fluid passage 94 is formed in which a lubricating fluid OL can be introduced from the outside of the supercharger 42 into the interior of the supercharger casing 66 and can then be introduced to the bearing housing 76. The supercharger lubricating fluid passage 94 is formed simultaneously with formation of the supercharger casing 66 by the use of a die forming technique. In the practice of the embodiment now under discussion, oil is used for the lubricating fluid OL.

An oil layer 96 is formed between the supercharger casing 66 and the bearing housing 76 and is in turn communicated with the supercharger lubricating fluid passage 94. Accordingly, the bearing housing 76 is supported by the supercharger casing 66 through the oil layer 96 for movement in a radial direction. The oil layer 96 has a function of relieving oscillations of the supercharger rotary shaft 44. A portion of the lubricating fluid OL in the oil layer 96 is supplied to the bearing 69 which is a component to be lubricated. The oil having passed through the right side bearing 69 is supplied to the external teeth 78 to thereby lubricate meshed portions between the external teeth 78 and the external teeth 81 of the planetary gear 80.

An oil sealing assembly SA is disposed between the bearing 69 and the impeller 60 in the supercharger rotary shaft 44. This oil sealing assembly SA includes: a tubular collar 75 mounted on the supercharger rotary shaft 44 and sandwich-to-held between the impeller 60 and an inner ring 69a of the left bearing 69; a sealing member 77 for preventing the leakage of the oil from the oil layer 96; and a seal retaining body 79 for retaining the sealing member 77.

The collar 75 is fixed to the supercharger rotary shaft 44, having been sandwiched between the impeller 60 and the inner race 69a of the bearing 69. The collar 75 forms a flanged portion of the supercharger rotary shaft 44. In place of the collar 75, a flanged portion may be integrally formed in the supercharger rotary shaft 44. The sealing member 77 stems a radial gap delimited between the collar 75 and the seal retaining body 79 to thereby prevent the flow of the oil towards the impeller 60 side. The seal retaining body 79 serves to retain the sealing member 77 and is supported by the supercharger casing 66 by means of a bolt (not shown).

A male threaded portion 95 is formed on an outer peripheral surface of a left side end portion (tip end portion) of the supercharger rotary shaft 44, and a fixture member 85 in the form of a fastening member such as, for example, a nut is threaded to the male threaded portion 95. The fixture member 85 presses the impeller 60 in the axial direction other side (left side of the motorcycle) of the supercharger rotary shaft 44 so as to contact the impeller 60 with the collar 75. By so doing, the impeller 60 is fitted to the supercharger rotary shaft 44.

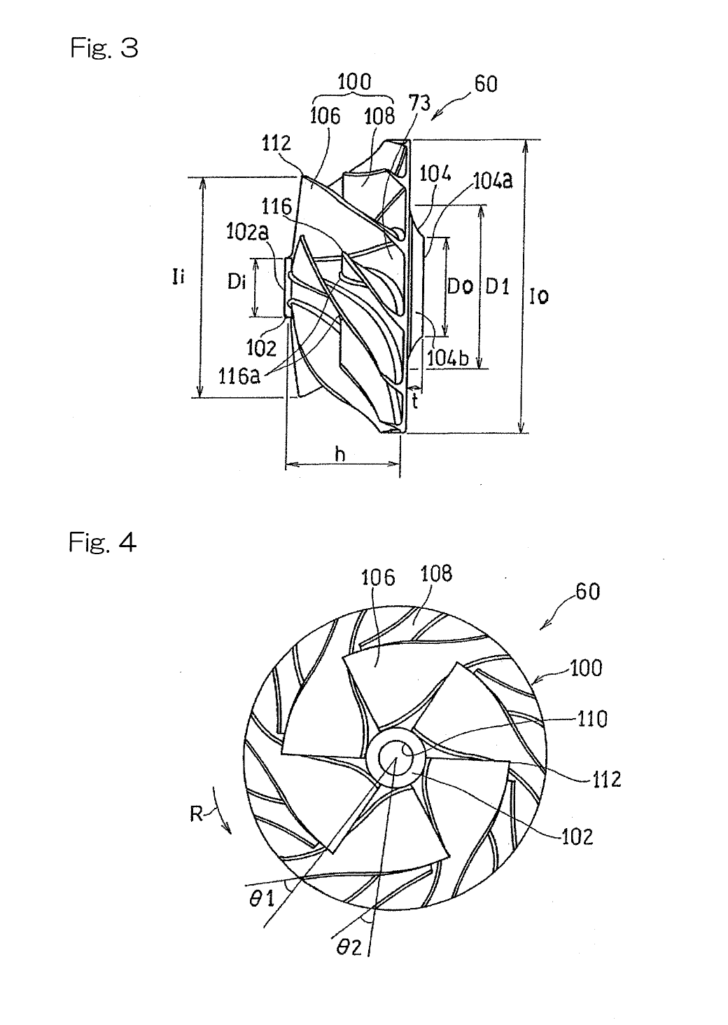

The impeller 60 is made of such a material having a small stress drop at elevated temperature, such as, for example, an aluminum alloy and includes a hub 73 and blades disposed on the outer periphery of such hub 73. This impeller 60 includes, as best shown in FIG. 3, an impeller main body 100 formed with the blades, a front end portion 102 protruding in an axially one direction (towards the left side) and terminating in contact with the fixture member 85 best (shown in FIG. 2), and a rear end portion 104 protruding in the axially other direction (towards the right side) and terminating in contact with the collar 75 (best shown in FIG. 2), which is the flanged portion of the supercharger rotary shaft 44. The rear end portion 104 has an end face 104a lying perpendicular to the rotational axis AX of the impeller 60.

It is to be noted that the front end of the impeller 60 and the rear end of the impeller 60 mean one end on one side in the direction of the rotational axis AX of the impeller 60 and on the other side in the direction of the rotational axis AX of the impeller 60, respectively. In other words, in the practice of the embodiment now under discussion, a forward and rearward direction of the impeller 60 and the forward and rearward direction or a longitudinal direction of the motorcycle are different from each other.

The impeller main body 100 includes a plurality of main blades (long blades) 106, which are disposed spaced a distance from each other in the peripheral direction, and a plurality of splitter blade (half blades) 108 each disposed between the neighboring main blades 106 that are disposed spaced a distance from each other in the peripheral direction. Each of the main blades 106 extends rearwardly from the front end portion 102 of the impeller 60, whereas each of the splitter blades 108 extends rearwardly from a position rearwardly of the front end of the adjacent main blade 106. In the practice of the embodiment now under discussion, the number of the main blades 106 and number of the splitter blade 108 are the same, in detail, six.

The outer diameter of the circle defined by an inlet side tip end portion of the impeller 60, that is, tip ends 112 at front edges of the main blades 106 is referred to as an inlet diameter Ii of the impeller 60 and the outer diameter of a rear edge of the impeller 60 is referred to as an outlet diameter Io.

The inlet diameter Ii and the outlet diameter Io of the impeller 60 are so set or determined as hereinafter described. The inlet diameter Ii of the impeller 60 is determined by the number of revolution of the impeller 60. In other words, since it has been empirically known that, when the peripheral velocity at the inlet side tip end portion 112 of the main blade 106 is in proximity to the sonic velocity, the efficiency becomes most ameliorated or highest. Accordingly, the inlet diameter Ii is preferably so determined that under a generally utilized region of the rotating speed (the number of revolutions), the peripheral velocity at the inlet side tip end portion 112 of the impeller may attain an sonic velocity.

Also, the inventors of the present invention have found that, if the peripheral velocity at the inlet side tip end portion 112 does not exceed the sonic velocity so much, reduction of the engine output is minimal. In other words, if the inlet diameter Ii is so set that the peripheral velocity at the inlet side tip end portion 112 when the supercharger 42 is driven at the maximum permissible engine speed may be a value somewhat to exceed the sonic velocity, the peripheral velocity at the inlet side tip end portion 112 can be brought close to the sonic velocity under the generally used region of the rotational speed without lowering the supercharging efficiency when the supercharger is driven at the maximum permissible engine speed. The term “maximum permissible engine speed” referred to above and hereinafter is to be understood as meaning the maximum design engine speed except for that occurring under the overrun condition of the engine which would be brought about by an abnormal reduction of the load.

More specifically, the inlet diameter Ii of the impeller 60 is preferably determined so that, when the supercharger 42 is driven at the maximum permissible engine speed, the peripheral velocity at the inlet side tip end portion 112 of the impeller 60 may exceed the sonic velocity and equal to or lower than 1.3 times the sonic velocity. By way of example, in the case of the conventional supercharger in which the peripheral velocity at the inlet side tip end portion 112 is set to a value in proximity to the sonic velocity, a sufficient flow rate could not be obtained since the inlet surface area becomes small. In contrast thereto, the outrt diameter, the inlet side tip end portion 112 employed in the practice of the present invention is so increased as to sufficiently secure the flow rate and, therefore, the output and the efficiency of the supercharger 42 can be increased.

In other words, assuming that the maximum speed of rotation of the engine is expressed by Nm (rev/min), the speed increasing ratio is expressed by a, and the sonic velocity is expressed by Vs (mm/s), the following formula (1) establishes:

[(Nm×α)/60]×π×Ii>Vs (1)

Since in the practice of the embodiment now under discussion the peripheral velocity is set to 1.3 times the sonic velocity, the inlet diameter Ii (mm) is set to the following range:

1.3×Vs>[(Nm×α)/60]×π×Ii>Vs

[(1.3Vs×60)/(Nm×π)]>Ii>[(Vs×60)/(Nm×π)]

In other words, where the maximum speed of rotation of the supercharger, after having been increased in speed, is 140,000 rpm, it can be concluded that the inlet diameter Ii is preferably set within the range lager than 45 mm and smaller than 59 mm. In the practice of the embodiment now under discussion, the inlet diameter Ii (mm) is set to 52 mm.

On the other hand, the outlet diameter Io of the impeller 60 is determined depending on the size of the impeller housing 63 shown in FIG. 2.

In other words, the size of the impeller 60, that is, the dimension (the heightwise dimension or the motorcycle longitudinal direction dimension) in a direction perpendicular to the axial direction of the impeller 60 is determined in dependence on the outlet diameter Io, and the size of the impeller housing 63 is proportional to the size of the impeller 60. In the practice of the embodiment now under discussion, since as hereinabove described, the supercharger 42 shown in FIG. 1 is disposed within the space delimited by the cylinder block 30, the cylinder head 32, the crankcase 28 and the intake air chamber 54, the outlet diameter Io of the impeller 60 shown in FIG. 3 is limited. Specifically, the outlet diameter Io of the impeller 60 is required to be a value equal to or smaller than 100 mm.

As hereinabove discussed, since the outlet diameter Io of the impeller 60 is required to be of a size suitable for the supercharger to be mounted on the motorcycle, the size thereof is limited. However, if the outlet diameter Io is too small, the efficiency will drop markedly as a result of an abrupt deflection. Therefore, in the practice of the embodiment now under discussion, the outlet diameter Io is chosen to be about 69 mm.

From those condition discussed above, the trim value TR is determined. The term “trim value” referred to above and hereinafter means the ratio of the inlet diameter Ii relative to the outlet diameter Io of the impeller 60, which is expressed by the following formula:

(Ii)²/(Io)²(unit: %)

The inventors of the present invention have found as a result of trial and error that the trim value TR of the impeller 60 is preferably chosen to be within the range of 50% or higher, and more preferably within the range of the value equal to 55% or higher and the value equal to or lower than 65%, i.e., within the range of 55 to 60%. In the practice of the embodiment now under discussion, about 57% has been chosen for the trim value of the impeller 60. At that time the inlet diameter Ii is about 52 mm, and the peripheral velocity at the inlet side tip end portion 112 attained 380 m/s (about 1.15×Vs).

It is known that the height h, which is the axial direction dimension of the impeller 60, is preferably within 0.3 to 0.4 times the outlet diameter Io. Since in the practice of the embodiment now under discussion, the size of the outlet diameter Io is limited in view of the space available for installation, the height h of the impeller 60 becomes correspondingly small. As a result, it is worrisome that the length of each of the blades 106 and 108 as measured in the direction of flow becomes small, Accordingly, the backward angle θ1 of each of the main blade 106 and the backward angle θ2 of each of the splitter blade 108, as shown in FIG. 4, are chosen to be a positive value. Thereby, the respective lengths of the blades 106 and 108 can be secured and a high efficiency can be realized.

The term “backward angle” referred to above and hereinafter means the impeller outlet angle, specifically the angle of inclination of an outlet end (rear edge) of the blade relative to the radial direction when the impeller 60 is viewed in the axial direction from an inlet side (front end side) of such impeller 60. Also, the wording “the backward angle is a positive value” referred to above and below means that the backward angle is inclined rearwardly in a direction conforming to the direction R of rotation of the impeller 60. Each of the backward angles θ1 and θ2 is preferably within the range of 30 to 50° and more preferably within the range of 35 to 45°. In the practice of the embodiment now under discussion, each of the backward angles θ1 and θ2 is about 40°.

The outer diameter Do of the end face 104a in the rear end portion 104 is so chosen to be larger than the outer diameter Di of the end face 102a in the front end portion 102 (i.e., Do>Di). Also, the outer diameter Do of the end face 104a in the rear end portion 104 is smaller than the inlet diameter Ii of the impeller main body 100 (i.e., Do<Ii). The front end face 102 of the impeller 60 forms a bearing surface with which the fixture member 85 is brought into contact, and the outer diameter Di of the end face 102a in the front end portion 102 is substantially equal to the diameter of the fixture member 85. Thus, choosing the outer diameter D1 substantially equal to the diameter of the fixture member 85 is effective to increase the inlet area to thereby increase the engine output. Also, the outer diameter Do of the end face 104a in the rear end portion 104 is set to a value larger than the outer diameter Di of the end face 102a in the front end portion 102 to thereby increase the strength, and therefore, a high speed rotation is enabled under the elevated temperature condition to achieve a further engine output increase.

The rear end portion 104 has the end face 104a, with which the collar 75 is brought into contact, and a reinforced portion 104b having its outer diametric dimension gradually increasing from the end face 104a towards the impeller main body 100. Specifically, the outer diametric dimension of the reinforced portion 104b is formed in a shape in which a plurality of radii of curvature each gradually increasing towards the impeller main body 100 are combined. Hence, each of the radii of curvature on the side of the impeller main body 100 is larger than the associated radius of curvature on the rear end side. Therefore, the stress concentration at the boundary portion between the impeller main body 100 and the rear end portion 104, that is, at the root portion of the rear end portion 104 is avoided. Also, the outer diametric dimension D1 of the boundary portion with the impeller main body 100 in the rear end portion 104 is larger than one half of the outlet diameter Io of the impeller 60 and smaller than the inlet diameter Ii of the impeller 60, i.e., Ii>D1>(Io/2).

Also, the outer diameter Do of the end face 104a is preferably within the range of 0.28 to 0.36 times the outlet diameter Io and more preferably within the range of 0.30 to 0.34 times the outlet diameter Io. In the practice of the embodiment now under discussion the outer diameter Do of the end face 104a is 0.32 times the outlet diameter Io. In addition, the outer diameter Di of the end face 102a is preferably within the range of 0.24 to 0.28 times the inlet diameter Ii and more preferably within the range of 0.25 to 0.27 times the inlet diameter Ii. In the practice of the embodiment now under discussion, the outer diameter Di of the end face 102a is 0.26 times the inlet diameter Ii.

Yet, a root portion 116a at a front end 116 of each of the splitter blades 108, which portion 116a is connected with the hub 73, is positioned inwardly of the circle depicted by the end faces 104a of the rear end portions 104 when viewed in the axial direction AX. Accordingly, in correspondence with the increase of the weight resulting from the use of the splitter blades 108, the radial dimension of the rear end portion 104 is increased so as to increase the strength of the rear end portion 104.

The dimension t of projection of the rear end portion 104 from the impeller main body 100 is set to a value larger than the difference between the radius r of a throughhole 110, through which the supercharger rotary shaft 44 shown in FIG. 2 is inserted, and the radius Di/2 of the end face 102a of the front end portion 102 shown in FIG. 3, that is, (t≧[(Di/2)−r]). As shown in FIG. 2, the end face 104a of the rear end portion 104 is opposed to the sealing member 77 in the axial direction. Also, the outlet diameter Io of the impeller 60 (best shown in FIG. 3), that is, the maximum diameter of the impeller 60 is so chosen to be smaller than the outer diameter P of the planetary gear device 64.

As shown in FIG. 5, each of the main blade 106 has a maximum thickness portion 114, which is the thickest portion, at an intermediate portion of the direction FD of flow of the intake air. The front end 116 of the splitter blade 108 and the maximum thickness portion 114 of the main blade 106 are displaced having been offset in the direction FD of flow relative to each other. Specifically, the front end 116 of the splitter blade 108 is positioned upstream side of the maximum thickness portion 114 of the main blade 106 with respect to the direction FD.

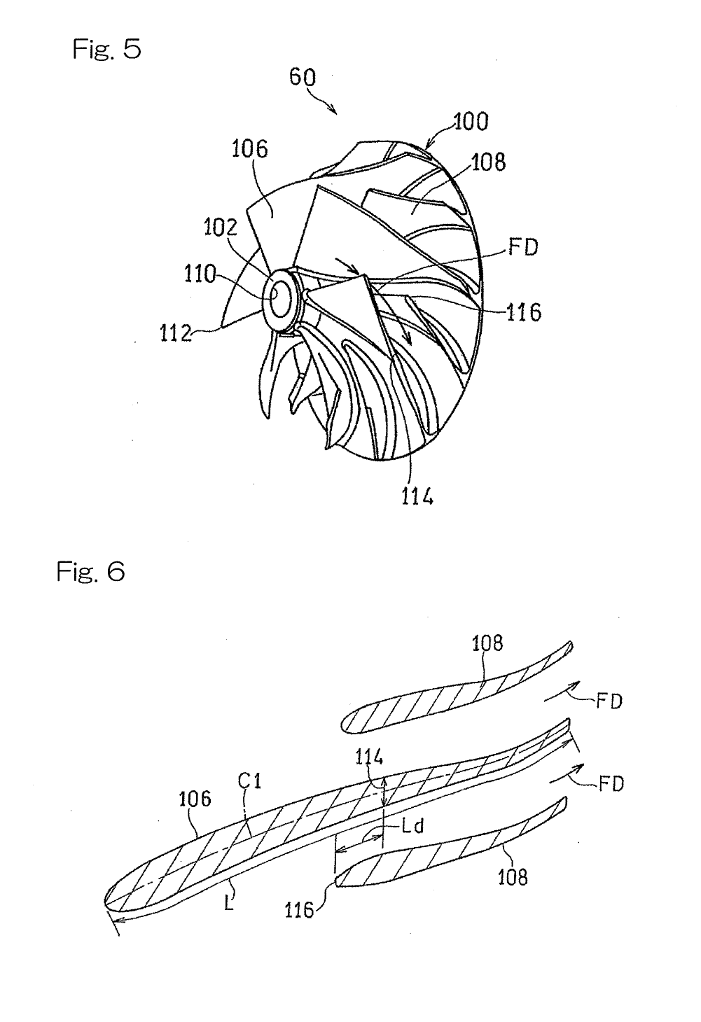

More specifically, relative to a length along a center line C1 of the transverse sectional plane of the main blades 106 shown in FIG. 6, a deviation dimension Ld between the maximum thickness portion 114 and the splitter blade 108 in the direction FD of flow is chosen to be Ld=( 1/10˜¼)·L, that is, 0.1 L≦Ld≦0.25 L. The wording “transverse sectional plane of the main blade 106” referred to above and hereinafter means a sectional plane, along the direction FD of flow, in the main blade 106.

In the description that follows, a method of making the impeller 60 will be discussed. At the outset, an original model of the impeller 60, which is in the form of a truncated cone, is formed by the use of a forging technique. Thereafter, a turning work takes place to form a schematic shape of the impeller 60. At this time, the impeller main body 100, the front end portion 102 and the rear end portion 104 are defined, but the blades 106 and 108 in the impeller main body 100 have not been formed yet. Subsequently, schematic shapes of the blades 106 and 108 are formed by the use of a crude processing. The crude processing is performed by the use of, for example, a large scale ball milling machine.

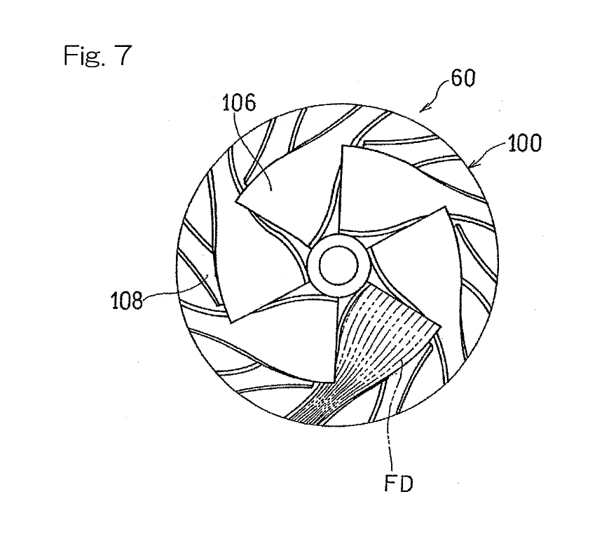

Finally, the blades 106 and 108 are formed to the final shapes by means of a precision work. This precision work is carried out by cutting with the use of a small sized end milling machine. During the precision work, as shown in FIG. 7, a surface of each of the blades 106 and 108 is cut in a direction conforming to the direction FD of flow of the intake air. Also, during the precision work taking place, front and rear surface of each of the blades 106 and 108 are simultaneously processed with the use of a common end mill.

The operation of the supercharger 42 will now be described. When the combustion engine E shown in FIG. 1 is started, the supercharger 42 is driven in driving association with the crankshaft 26. As hereinbefore described, the supercharger rotary shaft 44 shown in FIG. 2 is driven at a high speed, say, the maximum speed of 140,000 rpm. Since the supercharger 42 is operated at such a high speed, the highest centrifugal force acts on the rear end side portion 118 of the impeller main body 100 which has the largest outer diameter in the impeller 60. As a result, an outwardly oriented high tensile force is generated in the region AR on the rear end side of the impeller 60. As discussed above, since the intake air temperature at the outlet of the supercharger 42 attains about 100° C., the strength of the raw material may be lowered as compared with that under the normal temperature condition. Accordingly, there is a need is realized to prevent a deformation of the impeller 60 resulting from the centrifugal force during the high speed rotation.

In order to maintain the performance of the supercharger 42 while the impeller 60 is being downsized, speed-up of the rotation of the supercharger rotary shaft 44 is necessary. However, if such a speed-up is carried out, the high centrifugal force will occur as described previously. In the practice of the embodiment hereinabove described, the outer diameter Do of the end face 104a of the rear end portion 104 is chosen to be larger than the outer diameter Di of the end face 102a of the front end portion 102 and, therefore, the strength of the rear end portion 104 against the radially outwardly acting tensile force improves. Accordingly, even when the high tensile force acting radially outwardly is generated on the rear end side of the impeller main body 100 as a result of the high speed rotation of the supercharger rotary shaft 44, the possibility that the rear end side of the impeller main body 100 may be affected by such high tensile force can be suppressed. In view of this, the high speed rotation of the impeller 60 can be achieved.

It is, however, to be noted that the outer diameter Do of the end face 104a of the rear end portion 104 shown in FIG. 3 is smaller than the inlet diameter Ii of the impeller 60. Accordingly, while an undesirable increase of the size of the rear end portion 104 is avoided, an increase of the centrifugal force is suppressed, and, also, reduction of the weight of the impeller 60 can be achieved.

Also, since the outer diametric dimension of the rear end portion 104 is gradually increasing towards the impeller main body 100, the stress concentration on the boundary portion between the rear end portion 104 and the impeller main body 100 can be suppressed. Yet, the outer diametric dimension of the boundary portion is larger than ½ times the outlet diameter Io of the impeller main body 100, and smaller than the inlet diameter Ii of the impeller main body 100. Accordingly, while the rigidity of the rear end portion 104 is increased, an undesirable increase of the contour of the rear end side portion 118 of the impeller main body 100 is suppressed to allow the centrifugal force to be reduced.

The dimension t of projection of the rear end portion 104 from the impeller main body 100 is set to the value equal to or larger than the difference between the radius r of the throughhole 110 and the radius Di/2 of the end face 102a of the front end portion 102, i.e., (t>(Di/2)−r). Accordingly, the amount of projection of the rear end portion 104 becomes large, and thus, the possible reduction of the rigidity of the region AR (shown in FIG. 2) of the rear end side of the impeller main body 100 can be suppressed.

As shown in FIG. 2, the end face 104a of the rear end portion 104 is axially opposed to the sealing member 77. Accordingly, the axial gap between the sealing member 77 and the impeller 60 is reduced and, hence, any possible leakage of the lubricating fluid can be avoided.

In the construction hereinabove described, the peripheral velocity at the inlet side tip end portion 112 of the impeller is so set as to exceed the sonic velocity when the supercharger 42 is driven at the maximum permissible engine speed. Therefore, it is possible to bring the peripheral velocity within the normal operating region lower than the maximum engine speed close to the sonic velocity. As a result, the supercharging efficiency in the normal operating region becomes high and, therefore, the engine output improves. Also, the radial dimension of the inlet side tip end portion 112 of the impeller 60 is set to a value enough to allow the peripheral velocity thereof to exceed the sonic velocity to thereby secure the flow rate. Therefore, the undesirable increase of the outlet diameter Io, that is, the radial dimension of the supercharger 42 can be suppressed. Accordingly, the size of the supercharger 42 does not increase and, hence, the supercharger 42 can be disposed within the limited installation space in the motorcycle.

Also, the inlet diameter Ii of the impeller 60 is so set that the peripheral velocity at the inlet side tip end portion 112 during the maximum permissible engine speed may be equal to or lower than 1.3 times the sonic velocity. Accordingly, since even at the maximum permissible engine speed the impeller 60 rotates at a peripheral velocity proximate to the sonic velocity, and therefore, the output reduction at the maximum permissible engine speed can be suppressed. As a result, a good engine output can be obtained over a large range.

In addition, the trim value is set to a value equal to or higher than 50% and the output diameter Io becomes small, and therefore, the supercharger 42 can be easily mounted on the motorcycle having the limited space for installation. Also, since the height h (the motorcycle widthwise dimension) of the impeller 60 is determined depending on the outlet diameter Io (i.e., h=0.3˜0.4×Io), the smaller the outlet diameter Io, the larger the height h. In the practice of the embodiment discussed hereinabove, the supercharger 42 shown in FIG. 1 is accommodated within the width of the crankcase 28, and the suction port 46 is provided on the left side of the motorcycle body with the drive transmitting mechanism 74 (best shown in FIG. 2) provided on the right side thereof. Therefore, the space in the motorcycle widthwise direction is also limited. However, in the present embodiment the height h of the impeller 60 is reduced, and therefore, the supercharger 42 is further compactized. Accordingly, the supercharger 42 can be mounted within the limited space in the motorcycle widthwise direction.

Yet, the backward angles θ1 and θ2 of the main blade 106 and the splitter blade 108, respectively, are set to the positive values. If the impeller 60 is compactized in order to mount the supercharger 42 on the motorcycle, the blade length is apt to be reduced. However, with the backward angles θ1 and θ2 set to the positive values, the blade length can be earned. Therefore, while the compactization of the impeller 60 is achieved, the reduction in efficiency of the supercharger 42 can be suppressed.

The outlet diameter Io of the impeller 60 is chosen to be smaller than the outer diameter of the planetary gear device 64 best shown in FIG. 2. Even where the height h of the outlet diameter Io of the an impeller 60 is limited, selection of the positive value for each of the backward angles θ1 and θ2 allows the reduction of the efficiency of the supercharger 43 to be suppressed while the impeller 60 is compactized.

As shown in FIG. 6, the front end 116 of each of the splitter blades 108 and the maximum thickness portion 114 of each of the main blades 106 are disposed having been displaced in the direction conforming to the direction FD of flow of the intake air. Accordingly, the supercharging efficiency can be improved while an abrupt narrowing of the flow path in the presence of the splitter blades 108 is avoided.

As shown in FIG. 7, the surface of each of the blades 106 and 108 is formed by means of a cutting process performed in a direction conforming to the direction FD of flow of the intake air. Accordingly, since the intake air flows along processed grooves formed by the cutting process, the passage resistance or flow loss is reduced and, as a result, the efficiency of the supercharger 42 improves.

In the practice of the foregoing embodiment of the present invention, the rotation of the combustion engine E is transmitted to the impeller 60 through the planetary gear device 60 after the speed of the combustion engine E has been increased. Accordingly, without increasing the inlet diameter Ii, the flow rate can be earned. Also, in addition to the planetary gear device 64, the increase of the speed through a geared connection in the drive transmitting path allows the inlet diameter Ii to be further reduced in size. In other words, by setting the speed increasing ratio so that the inlet diameter Ii and the outlet diameter Io can be made smaller than the outer diameter P of the planetary gear device 64, the increase in size of the supercharger 42 can be suppressed and, also, the possibility of the speed increasing ratio to become excessive can be avoided.

In addition, even where the trim value is relatively small and the radial dimension of the blade becomes small, by setting the backward angle to a positive value, the radial dimension of the blade is increased to increase a guide surface for an air brought about by the blades. Accordingly, the reduction in supercharging efficiency brought about by the small trim value can be suppressed. Also, even where the height h of the impeller 60 is small and the axial dimension of the blade becomes small, by setting the backward angle to a positive value, the blade length along the center line C1 of a transverse section of the blade is increased, and thus, the guide surface for the air brought about by the blades can be increased. Accordingly, the reduction in supercharging efficiency resulting from the reduction of the height h of the impeller 60 can be suppressed.

In order to compactize the supercharger 42 discussed in connection of the foregoing preferred embodiment of the present invention, reduction of the height h (motorcycle widthwise direction dimension) of the impeller 60 is preferred. In other words, in the supercharger 42 according to the foregoing preferred embodiment, the supercharger casing 66 is disposed on the right side of the impeller housing 63, the air cleaner 40 is disposed on the right side of the impeller housing 63, and the impeller housing 63, the supercharger casing 66 and the air cleaner 40 are accommodated within the width of the crankcase 28. Also, the air intake duct extending in the longitudinal direction of the motorcycle is bent in the motorcycle widthwise direction to be fluid connected with the air cleaner 40. Therefore, the space available in the motorcycle widthwise direction is further pressured. Even where the compactization of the height h of the impeller 60 is required in this way, setting the backward angle to the positive value as hereinabove discussed is effective to suppress the possible reduction of the supercharging efficiency.

In other words, the outlet diameter Io is so set as to reduce as compared with the outer diameter P of the planetary gear device 64, the inlet diameter Ii is so set as to allow the peripheral velocity to exceed the sonic velocity and the speed increasing ratio is so set as to satisfy those conditions. By so doing, the engine output can be improved, while the increase of the size of the supercharger 42 is avoided, and the mounting capability onto the motorcycle can be improved.

Where the peripheral velocity of the inlet side tip end portion 112 exceeds the sonic velocity, provided that it may be within a predetermined value exceeding the sonic velocity, the width of decrease of the engine output is small. However, if the peripheral velocity exceeds this predetermined range, the width of decrease of the engine output becomes large. In the practice of the present invention, under the maximum speed the peripheral velocity of the inlet side tip end portion 112 is so set as to exceed the sonic velocity and retain within the predetermined range. This predetermined range can be determined by experiments or simulations.

Each of the embodiments hereinabove described can be embodied in the following modes in which the particulars of the “inlet diameter of the impeller” are not essential.

### [Mode 1]

An impeller of the supercharger according to the mode 1 is a centrifugal impeller which impeller is fixed, with the use of a fixture member, on a supercharger rotary shaft that is inserted through a throughhole defined in the impeller,

the impeller comprising:

an impeller main body formed with blades;

a front end portion protruding towards one axial side from the impeller main body and held in contact with the fixture member; and

a rear end portion protruding towards the other axial side from the impeller main body and held in contact with a flanged portion of the supercharger rotary shaft, wherein

an outer diameter of an end face of the rear end portion is so set as to be larger than an outer diameter of an end face of the front end portion.

According to the construction employed in the practice of the mode 1 above, since the outer diameter of the end face of the rear end portion is set to a value larger than the outer diameter of the end face of the front end portion, the strength against the tensile force acting to pull the rear end portion in the radial outward side improves. Accordingly, in the event that the supercharger rotary shaft is driven at a high speed, even when the high tensile force acting in the radially outer side as a result of the centrifugal force acts on an outer peripheral portion on the rear end side of the impeller main body, at which outer diameter is largest, the possibility that the rear end side of the impeller main body is affected by such tensile force can be suppressed. Accordingly, the impeller can be driven at a high speed.

### [Mode 2]

In the mode 1 referred to above, an outer diameter of the end face of the rear end portion may be smaller than the outer diameter of the front end portion of the impeller main body.

### [Mode 3]

In the mode 1 or mode 2 referred to above, an outer diametric dimension of the rear end portion may gradually increase from the end surface thereof towards the impeller main body,

while an outer diametric dimension of a boundary portion between the impeller main body and the rear end portion may be larger than half an outer dimension of a base end of the impeller main body, and smaller than an outer dimension of the tip end of the impeller main body.

### [Mode 4]

In any one of the modes 1 to 3 referred to above, a dimension of projection of the rear end portion from the impeller main body may be set to a value larger than a difference between the radius of the throughhole and a radius of the end face of the front end portion.

### [Mode 5]

In any one of the modes 1 to 4 referred to above, the rear end portion may be axially opposed to the sealing member disposed radially outwardly of the flanged portion.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, although in describing the foregoing preferred embodiment of the present invention reference has been made to the impeller having the main blade 106 and the splitter blade 108, the present invention is not necessarily limited to such impeller, but may be equally applied to any impeller having no splitter blade 108.

Accordingly, such changes and modifications are, unless they depart from the scope of the present invention as delivered from the claims annexed hereto, to be construed as included therein.

### REFERENCE NUMERALS

26: Crankshaft
42: Supercharger
44: Supercharger rotary shaft
46: Suction port
60: Impeller
64: Planetary gear device
74: Chain (Drive transmitting mechanism)
106: Main blade
108: Splitter blade
112: Inlet side tip end portion
114: Maximum thickness portion of the main blade
116: Front edge of the splitter blade
E: Combustion engine
Ii: Inlet diameter
Io: Outlet diameter
TR: Trip value

What is claimed is:

1. A centrifugal impeller for a supercharger drivingly connected with a crankshaft of an engine, mounted on the motorcycle, the impeller supplying an intake air towards the combustion engine,
in which, as the supercharger is driven at a maximum permissible engine speed, an inlet diameter of the impeller is chosen to be a value that allows a peripheral velocity of an inlet side tip end portion of the impeller to exceed the sonic velocity.

2. The centrifugal impeller for the supercharger as claimed in claim 1, wherein the inlet diameter is so set that the peripheral velocity of the inlet side tip end portion of the impeller at the maximum permissible engine speed is equal to or lower than 1.3 times the sonic velocity.

3. The centrifugal impeller for the supercharger as claimed in claim 1, wherein a trim value is equal to or higher than 50%.

4. The centrifugal impeller for the supercharger as claimed in claim 1, wherein a backward angle of the blade is set to a positive value.

5. The centrifugal impeller for the supercharger as claimed in claim 4, wherein:
rotation of the crankshaft is transmitted to a supercharger rotary shaft, on which the impeller is fixed, through a planetary gear device;
the planetary gear device transmits the rotation of the crankshaft to the supercharger after the speed of such rotation has been increased;
the impeller is fixed on one end portion of the supercharger rotary shaft, and the planetary gear device is connected with the other end portion of the supercharger rotary shaft; and
an outlet diameter of the impeller is set to a value smaller than an outer diameter of the planetary gear device.

6. The centrifugal impeller for the supercharger as claimed in claim 1, comprising:
a plurality of main blades disposed spaced a distance from each other in a peripheral direction; and
a plurality of splitter blades each disposed between the neighboring main blades, wherein
each of the main blades has a maximum thickness portion defined at an intermediate portion with respect to a direction of flow, the maximum thickness portion having a maximum thickness; and
each of the splitter blades has a front edge, positions of which front edge and the maximum thickness portion of the corresponding main blade are displaced in the direction of flow of intake air.

7. The centrifugal impeller for the supercharger as claimed in claim 1, comprising a blade, a surface of which is formed along a direction of flow of the intake air by means of a cutting process.

8. The centrifugal impeller for the supercharger as claimed in claim 1, which impeller is fixed, with the use of a fixture member, on a supercharger rotary shaft that is inserted through a throughhole defined in the impeller,
the impeller comprising:
an impeller main body formed with blades;
a front end portion protruding towards one axial side from the impeller main body and held in contact with the fixture member; and
a rear end portion protruding towards the other axial side from the impeller main body and held in contact with a flanged portion of the supercharger rotary shaft, wherein
an outer diameter of an end face of the rear end portion is so set as to be larger than an outer diameter of an end face of the front end portion.

9. The centrifugal impeller for a supercharger as claimed in claim 8, wherein the outer diameter of the end face of the rear end portion is smaller than the inlet diameter of the impeller.

10. The centrifugal impeller for the supercharger as claimed in claim 8, wherein:
an outer diametric dimension of the rear end portion gradually increases from the end face thereof towards the impeller main body; and
an outer diametric dimension of a boundary portion between the rear end portion and the impeller main body is larger than half an outer diametric dimension of a base end of the impeller main body, and smaller than an outer diametric dimension of a tip end of the impeller main body.

11. The centrifugal impeller for the supercharger as claimed in claim 8, wherein a dimension of projection of the rear end portion from the impeller main body is set to be larger than a difference between a radius of the throughhole and a radius of the end face of the front end portion.

12. The centrifugal impeller for the supercharger as claimed in claim 8, wherein the rear end portion is opposed axially to a sealing member disposed on a radially outward side of the flanged portion.

13. A centrifugal impeller for a supercharger which impeller is fixed, with the use of a fixture member, on a supercharger rotary shaft that is inserted through a throughhole defined in the impeller,
the impeller comprising:
an impeller main body formed with blades;
a front end portion protruding towards one axial side from the impeller main body and held in contact with the fixture member; and
a rear end portion protruding towards the other axial side from the impeller main body and held in contact with a flanged portion of the supercharger rotary shaft, wherein
an outer diameter of an end face of the rear end portion is so set as to be larger than an outer diameter of an end face of the front end portion.
